(19) United States
(12) Patent Application Publication
(10) Pub. No.: US 2019/0272094 A1
(43) Pub. Date: Sep. 5, 2019

(54) SYSTEM FOR MULTI-TAGGING IMAGES

(71) Applicant: Jack M. MINSKY, Boston, MA (US)

(72) Inventor: Jack M. MINSKY, Boston, MA (US)

(21) Appl. No.: 16/285,728

(22) Filed: Feb. 26, 2019

Related U.S. Application Data
(60) Provisional application No. 62/636,841, filed on Mar. 1, 2018.

(51) Int. Cl. G06F 3/0488; G06F 3/0484; G06F 3/16

(52) U.S. Cl. CPC G06F 3/04886; G06F 3/165; G06F 3/04842

(57) ABSTRACT

A system with a simple, intuitive, efficient interface is described for creating multi-tagged image files and playing back the tags upon demand. The system includes a display for displaying the image to a user, a user interface is adapted to receive user input to create a touch-sensitive zone around each selected location, a recording device for creating an object associated with each touch-sensitive zone and a packing device that merges the image, the touch-sensitive zones and their associated objects into a tagged image file having a unique filename extension indicating that it is a tagged image file, and saving the tagged image. On playback, the image is displayed to the user who may select a touch-sensitive zone. The object file associated with that zone is played back. The user may also select an option that causes the objects to autoplay in a pre-determined sequence. The user may also delete, edit, or re-record objects.

### CROSS REFERENCE TO RELATED APPLICATIONS

The current application claims priority to U.S. Provisional Patent Application 62/636,841 filed Mar. 1, 2018 “System for Multi-tagging Images” by Jack M. Minsky, the same inventor as the current application. This provisional application is hereby incorporated by reference into the current application to the extent that it does not contradict the current application.

### STATEMENT REGARDING FEDERALLY SPONSORED RESEARCH

Not applicable.

### BACKGROUND OF THE INVENTION

### 1. Field of the Invention

The current invention is an easy to use, intuitive system for tagging images with multiple embedded recordings on each image which can then be replayed by simply selecting (for example by tapping or clicking) the touch-sensitive zones on the image where object data is embedded. If the object data is an audio clip, each such zone is referred to as a “sound spot.”

### 2. Description of Related Art

Digital images, which may be photographs or graphics, are captured or imported and then viewed on various computing equipment, such as ‘smart’ cell phones, computing tablets, laptops, desktops and other computing equipment which will be collectively referred to as “computing devices.”

### Audio Notations

There are devices that can overlay visual information to provide information about the image. However, using live objects, such as audio recordings or video/audio clips, adds value to the image.

There have been attempts to add audio annotation to an image, such as described in US 2007/0079321 A1 Ott, I V, published Apr. 5, 2007, titled “PICTURE TAGGING” (“Ott”). Ott described linking a pre-existing media file, such as a still image, to another media file, such as an audio media file. Ott disclosed using conventional file formats. Together, these files would provide a single audio explanation of the overall image without specifically identifying any location or features of the image.

### Need Both Files

The image and audio files in Ott's invention must be kept together, and not as separate and different files to be rendered together. If these files were not kept together, either the image or sound annotation would be lost during playback.

Since images are intended to be saved for a long period of time, it is important that they can be recovered and played back at a much later time. It is difficult to keep two files together for a long period of time. Copying and transferring files over a period of time may result in these files being stored in different folders/locations. If both are not available at the time of playback, either the image or tagging will be lost.

### Applies to Overall Image

As indicated above, the tagging comments referred to in Ott apply to the entire image, and not to any specific location(s) on the image.

### Changing Media Formats

Media players and their corresponding file formats are constantly being updated with new versions of media players. Also, new media players and formats are constantly being developed and implemented. Since there are many formats, and many versions of each format, it is not possible to support them all. Therefore, each media player supports only a few selected formats and versions. Usually, older versions are dropped and no longer supported. Therefore, if the newer media player versions are not ‘backward compatible’ to the version of the image/audio files, they may not be capable of playing the image/audio files even though those files are of the same format but are older versions.

Therefore, many old files may not be able to be played if current players do not support a format/version that is compatible with the old files. For example, it is possible that the user has an image and a corresponding tagging file but does not have a compatible player.

This can become a problem since it is common to archive old pictures and view them many years later.

### Less Intuitive

Prior art methods of linking an image file to a tagging file took some degree of editing or set up and were not very intuitive. Most require several steps including entering an edit mode, selecting objects, tagging those objects, and then copying them to a file or program. This process can become cumbersome when a user is trying to tag many images. This is especially true when a user is attempting to capture a stream of information from recalled memories, which once the flow is interrupted may be frustratingly lost, especially when elderly users are recalling events that took place decades earlier.

These prior art methods typically require significant editing capabilities and are difficult to implement on tablets or smart phones.

Currently, there is a need for a system which can quickly, easily, and without interruption allow creation and playback of an image with multiple tags, each associated with a portion of the image.

### BRIEF SUMMARY OF THE INVENTION

The current invention may be described as a system for tagging an image having a user interface for displaying the image to a user 1, and to acquire a plurality of user-defined locations on the image and enlarge each user-defined location into a touch-sensitive zone. An object input device is adapted to acquire audio or visual object data. A memory has locations for storing executable code, the acquired image, audio/object data, touch-sensitive zones, and object tagged images. A recording device is adapted to selectively receive object data from object input device and to store the object data in memory.

A controller is coupled to the memory adapted to run executable code stored in the executable memory, to control the user interface, to display the image, to receive user input defining locations on the image, to create touch-sensitive zones around the user-defined locations, to associate (tag) the touch-sensitive zones with objects acquired by the recording device, and to store the images, tagged touch-sensitive zones and associated objects as a unitary file in the memory.

The current invention may also be described as an object tagged image (OTI) file having a uniform filename extension, created by the steps of acquiring an image, displaying the image to a user on a user interface, identifying a plurality of user-selected locations on the image with the user interface, expanding the acquired locations into touch-sensitive zones with a controller, acquiring a plurality of sets of object data, and associating each set of object data with at least one touch-sensitive zone.

It also employs a packing device to merge the image, touch-sensitive zones and sets of object data into an object tagged image (OTI) file. It then creates a magnetic representation of the OTI file in a non-volatile memory device including a filename having an indication that it is an OTI file.

The current invention may also be described as a method of playing back pre-stored object in an object tagged image (OTI) file, by executing the steps of employing a playback device to acquire at least one file, reading an indication by a controller of the acquired file format indicating that the file is an OTI file, extracting a prestored image from the OTI file, displaying the image on a user interface, and identifying in the OTI file a plurality of touch-sensitive zones. The user interface is monitored to identify when a touch-sensitive zone on the displayed image is touched, clicked, or otherwise selected, playing an object associated with the touch-sensitive zone touched with the playback device. Alternatively, the user may select an autoplay option, causing the objects associated with the touch-sensitive zones to be highlighted and play in a pre-determined order.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted to facilitate a less obstructed view of these various example embodiments.

FIG. 1 illustrates a general overall schematic diagram of a tagging device according to one embodiment of the current invention.

FIGS. 2A-2D together are a flowchart illustrating the functioning of the tagging system of FIG. 1.

FIG. 3 is an illustration of a screen of a computing device of the tagging system of FIG. 1 used in connection with an explanation of its functioning.

FIG. 4 is an illustration of a non-volatile memory device having an internal magnetic encoding on a plurality of memory elements, representing the data and code stored.

### DETAILED DESCRIPTION

### Theory

### Tagging Images

As there is a story inherent in photographs of people, places, and objects, the value of an image may be greatly enhanced by permanent recordings made by someone familiar with what is depicted when those recordings can be retrieved simply by tapping touch-sensitive zones to hear those stories retold any time in the future. While this is quite true of newly taken photographs, it is even more so regarding older photographs when there is someone still alive who remembers the people and places captured in them or when a descendent or historian wishes to learn about the people and places pictured. The memories captured and associated with such touch-sensitive zones will be invaluable to the family historian. And it isn't difficult to imagine the delight of generations to come when they tap a face in a touch-sensitive zone of an enhanced digital photograph and hear their great grandmother's voice telling them one by one about a dozen relatives pictured at a wedding that took place a hundred years ago. This would be very valuable in genealogy software.

The ease of use of the current invention makes it especially useful in schools, where a student might document the process of creating a third-grade project with a background recording then tap an object or region and record a description of it, and, without stopping, tap another region and record another explanation and so forth until a full expression of the meaning they have embodied in their creation is captured in the image. The simplicity has the potential to provide great benefits in the enhancement of student presentation skills and personal expression and to allow teachers to review the thinking behind art to understand how a student perceives it in evaluating that work.

One requires a recording device to capture images, audio or other physical phenomena as a datafile. A playback device is capable of receiving the datafile and reversing the process to display the images, and playback audio and other objects. The playback device must be able to decode the datafile created by the recording device.

If more than one type of physical phenomena is being captured (images and audio), then the playback device should be able to fully decode the datafile back into the same number of physical phenomena (image and audio). Both playback devices (image and audio) should be compatible with both datafile formats (image and audio).

A recording device is required only when one would like to add/delete or modify the tags of an image. If one simply wants to play back the tags, a recording device is not required.

Recording devices and playback devices may have hardwired buttons to perform specific functions. Soft buttons also may be implemented in software in which buttons may be displayed on a screen, and a function implemented when the button is touched, in the case of a touch-sensitive screen, or has been clicked on, in the case of mouse-controlled graphic user interfaces. The recording device has logic which monitors the buttons and performs a function associated with the button when the button is selected.

One of the button selections of the recording device selects an option to encode signals into object data associated with a touch-sensitive zone, also referred to as a ‘tag’ file. The object data, touch-sensitive zones, and image are stored as an object tagged image (OTI) file. Encoding may be done by a coding device or by a routine referred to as a codec.

It is envisioned that one output type for the object tagged image file would be an HTML5 file. This file can then be opened on any modern web browser on a computing device and the touch-sensitive zone may then still be tapped for playback or played in presentation mode. The playback device may be implemented in hardware, software or a combination of both. This adds to the longevity of the current system and its file type.

In another embodiment, the playback device can be separated into a codec that decodes the datafile and elements that run all other functions such as displaying and monitoring a user interface.

Portions of the executable code to operate the playback device may be copied to the tagged image file.

The codecs used by the playback device to decode the tagged image file may also be copied to the tagged image file.

Any code that is stored in the datafile is guaranteed to be available when the datafile is played back. However, as more executable code is stored in the datafile, the larger the datafile becomes. Therefore, it is a trade-off as to what should be stored in the datafile.

In the Windows Operating System, the Macintosh Operating System, the iOS Operating System, the Android Operating System, and other operating systems, each file is given a filename with an extension (following a period). This defines the format of the file. It is proposed that at least one new extension be defined for the datafiles described above. The recorder will operate to create data files having the same unique filename extension indicating the file types.

### Implementation

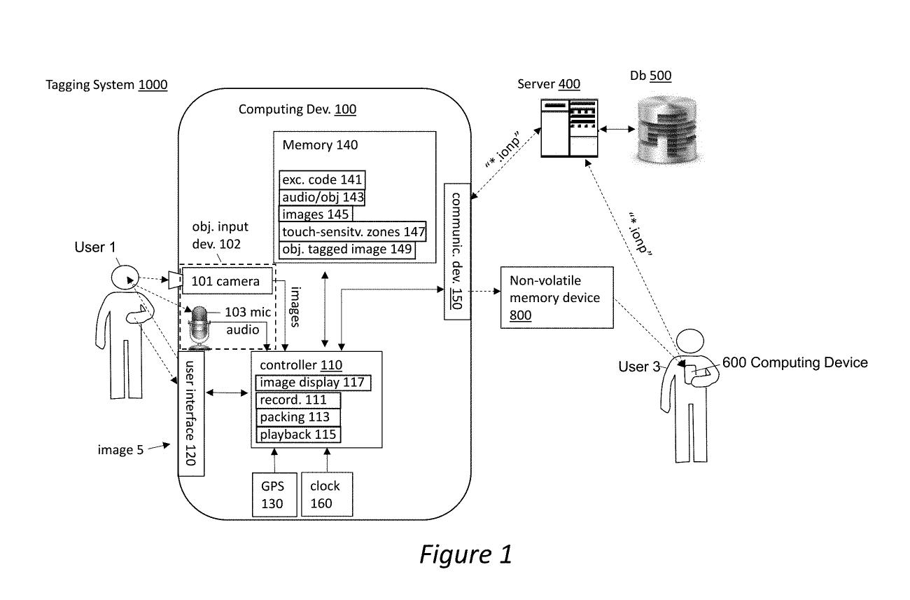

FIG. 1 illustrates a general overall schematic diagram of a tagging device according to one embodiment of the current invention.

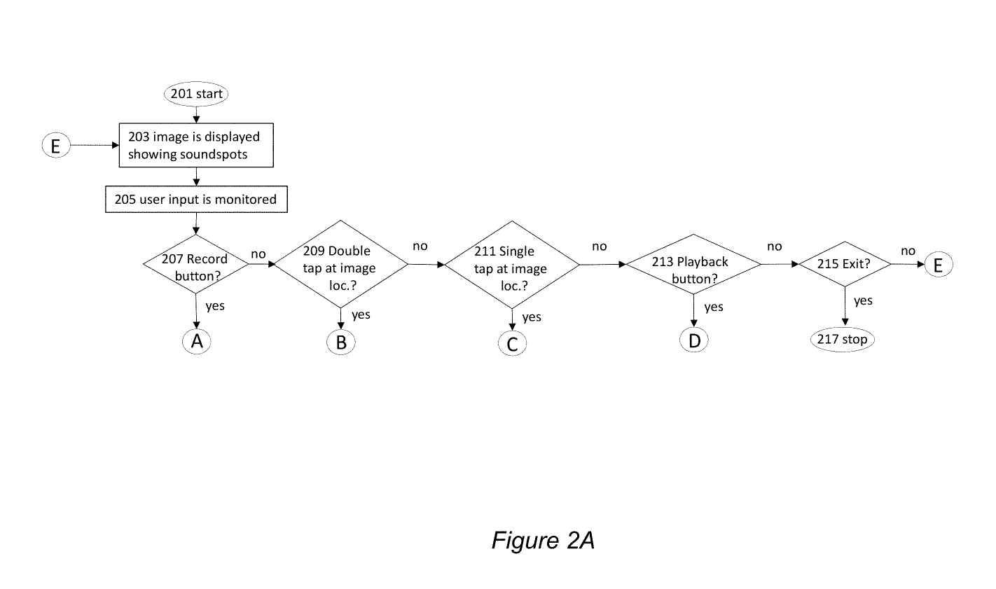

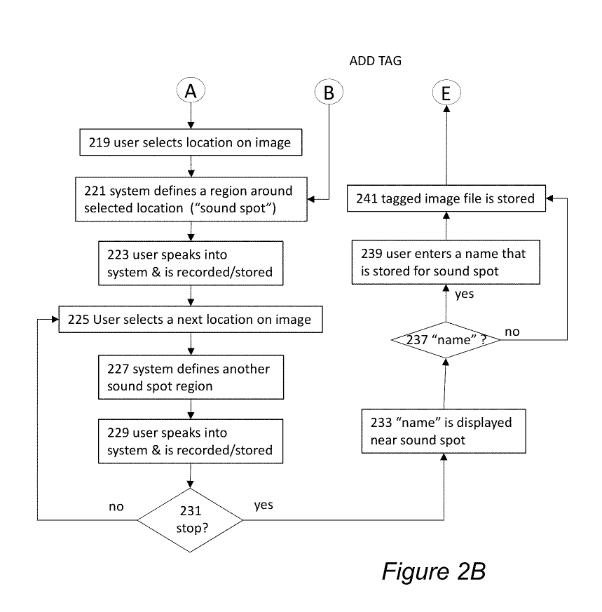

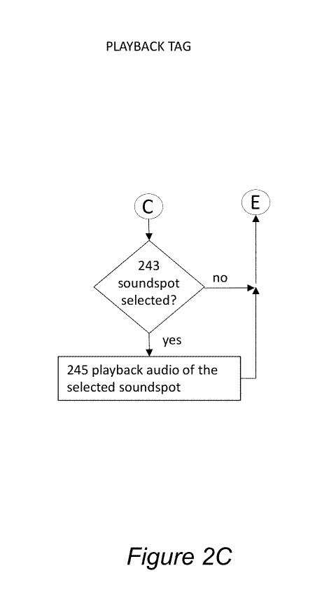

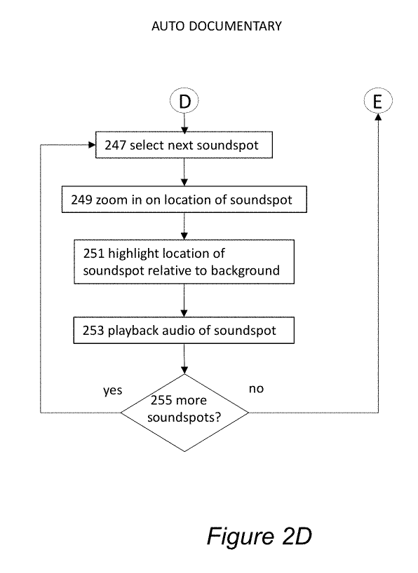

FIGS. 2A-2D together are a flowchart illustrating the functioning of the tagging system of FIG. 1.

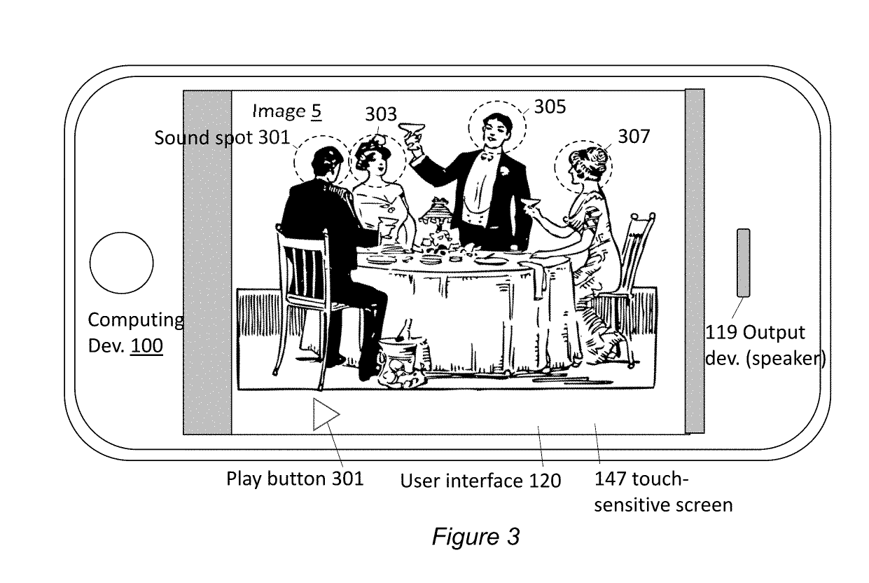

FIG. 3 is an illustration of a screen of a computing device of the tagging system of FIG. 1 used in connection with an explanation of its functionality.

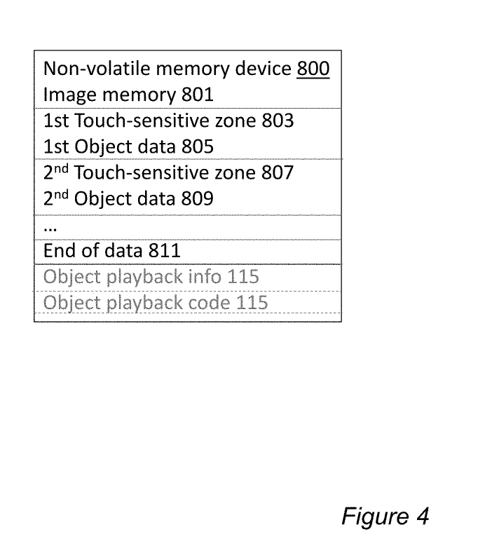

FIG. 4 is an illustration of a non-volatile memory device having an internal magnetic encoding on a plurality of memory elements, representing the data and code stored.

The tag recording and editing functions of the tagging system 1000 will be explained in connection with FIGS. 1, 2A-2D, 3 and 4. This applies to a system which has both record and playback functionality.

A user 1 has a ‘smart’ cell phone, computing tablet, laptop, desktop, or other computing equipment, which will be referred to as a “computing device” 100. Another user 3 is shown with a similar computing device 600 that also communicates with the tagging system 1000.

Computing device 100 has a user interface 120 which may be a conventional input or output device used with computing equipment. Preferably this is a touch-sensitive display commonly used with smart phones and tablets.

Computing device 100 has a controller 110 which can read and execute executable code 141 stored in memory 140. This executable code 141 may be referred to as an “App.”

The controller 110 employs an image display device 117 for displaying the image and a recording device 111 for creating an object datafile. In the example embodiment, recording device 111 records audio from the microphone 103, encodes it into an object datafile and stores it in audio/object memory 143 of memory 140.

The recording process begins at step 201 of FIG. 2A.

In step 203, user 1 interacts through user interface 120 with controller 110 to load an image that was pre-stored in image memory 145 of memory 140. The image is displayed on user interface 120 with any user-defined regions of the image having an object, such as a recording of a voice description associated with that region, which is referred to as a “SoundSpot,” as indicated in step 203.

In an alternative embodiment, controller 110 connects to a server 400 through a communication device 150 to download a pre-stored image. The server 400 communicates with a database 500. This would be the case when images are stored in a “cloud.”

In step 205, the user input is monitored. In this preferred embodiment, user interface 120 is a touchscreen. Other buttons, such as a “Record,” “Stop,” and “Playback” may be displayed on the touchscreen.

In step 207, if it is determined that user 1 has selected the “Record” button displayed on the display screen, or in step 209 the user double taps the display screen, the system drops into the record mode indicated by FIG. 2B.

Processing then continues to step 219 of FIG. 2B if the “Record” button was selected. If the screen was double tapped, then processing continues at step 221. In step 219, the user selects a location on the displayed image. Since this example is using a touchscreen, this is simply done by touching the intended location on the image. Other appropriate input hardware may be used with other systems, including a mouse, trackball, or virtual reality headset to select locations on the image.

In step 221, the system defines a region around the selected location that can be tagged with an object, referred to as a touch-sensitive zone. (If the touch-sensitive zone is associated with a sound clip, it is referred to as a “SoundSpot.”) By selecting anywhere in this touch-sensitive zone, the user may add or play back object data which may be audio, video or notations.

When a user indicates that he/she wants to enter the recording mode by double tapping the touchscreen, processing continues at step 221, since step 219 has already been completed.

In step 223 the user simply speaks to the tagging system 1000 and the speech is automatically recorded, associated with the touch-sensitive zone and stored in touch-sensitive zone memory 147.

In step 225, the user selects another location on the image, as before, the system defines a touch-sensitive zone in step 227 and the user may immediately begin speaking to the tagging system 1000. This is associated with the touch-sensitive zone and stored in touch-sensitive zone memory 147.

FIG. 2B describes an embodiment with at least two touch-sensitive zones being recorded initially, but it is also possible to have an embodiment that only requires the user to create one initial touch-sensitive zone.

In step 231, the tagging system 1000 determines if the user has selected the “Stop” button on the touchscreen, or otherwise has indicated that he/she is finished adding tags to the image.

If the user would like to continue creating additional tags, the user can continue to select locations on the image and provide descriptions. This fast, intuitive and easy interface will allow a user to tag many locations of an image quickly and without having to enter a library, select, open and close routines to set up tags.

Once the audio tags have been added, the system automatically goes back to each unnamed touch-sensitive zone and prompts the user for a name in step 237.

If the user does not have a name or does not want to add a name (“no”) then processing continues at step 241. If the user wants to add a name, then in step 239, the user enters a name for that touch-sensitive zone.

In step 241, the object tagged image file is stored in memory 149.

Processing then continues by returning to step 203 of FIG. 2A.

As is shown above, the current invention can record audio with a single click for each touch-sensitive zone, and record multiple touch-sensitive zones sequentially, unlike the prior art. This makes tagging photos intuitive, easy and efficient.

Returning back to processing at step 211 of FIG. 2A, if the user single taps the image on the touchscreen, (“yes”), then processing continues at step 243 of FIG. 2C.

In step 243, it is determined whether the screen location selected is within a touch-sensitive zone.

If so (“yes”), in step 245, the audio recorded for this touch-sensitive zone is taken from audio memory 143 of FIG. 1 and played back by playback device (119 of FIG. 3), which is an audio speaker for audio objects.

Processing then continues at step 203 of FIG. 2A.

### Auto Playback Mode

Auto playback is described in connection with FIGS. 2A, 2D and 3.

If at step 213 of FIG. 2A, the controller 110 senses that the user has selected an “Auto Playback” button on user interface 120 rather than one of the “touch-sensitive zones,” processing then continues at step 247 of FIG. 2D.

This starts an auto-playback mode which is a kind of mini-documentary playing the sounds associated with the image overall first. As an example, FIG. 3 shows an image 5 of a wedding. An audio tag for the overall image is played that states “This is Mimi's wedding at the Waldorf” which describes the photograph in which a few wedding guests appear. There are four touch-sensitive zones 301, 303, 305 and 307 in this photograph marking the face of each guest. In step 247 of FIG. 2D, a first touch-sensitive zone is selected. This is touch-sensitive zone 301 of the head of Uncle Al.

In step 249 the viewpoint is zoomed into Uncle Al's head.

In step 251, the touch-sensitive zone is made brighter than the background to bring attention to Uncle Al's head while in step 253 the description of Uncle Al is played.

In step 255, the system determines if there are other touch-sensitive zones on this image. If so (“yes”), processing continues at step 247.

In step 247 the touch-sensitive zone 303 of Aunt Nell is selected by the system.

The process is repeated for steps 249-255 for each of the touch-sensitive zones.

In turn each touch-sensitive zone sound is played while automatically zooming into each touch-sensitive zone of a guest (or even the wedding cake) as it is being played while dimming the rest of the image to provide emphasis on the person or object being talked about in that recording. Finally, the user can change the order of playback of the touch-sensitive zones just by dragging images corresponding to the tagged portions to rearrange them in a tray at the bottom of the screen. This requires a minimum of effort and is very easy to operate.

During the recording phase, when a user is done recording a series of touch-sensitive zones in a photo, the user is presented an opportunity to enter a name for each touch-sensitive zone identifying that person, object or area in the image, or to “skip” to the next person, object, or area.

Explained more directly, the current invention exhibits increased ease of use, as a user clicks an obvious red “record” button and gets an instruction to tap on any spot to record something about it. In another embodiment, the user may double-tap, double click or use another commonly known user input action to record an overview of the entire picture (which might be a description of the location for example). When finished recording, the user may either tap another spot to start a recording there or tap the square stop button to end record mode. This is more elegant than the tap and hold alternate approach—the user just keeps tapping and recording with no decisions or tradeoffs to make.

### Touch-Sensitive Zone Size/Shape

In one embodiment, the controller 110 defines a region around the location selected by the user. This may have a defined radius in one embodiment.

In another embodiment, the radius may be selected based upon the size of objects in the image.

In another embodiment, the system can use image segmentation principles to identify objects in the image. The touch-sensitive zone is then identified as the segmented object which has the location selected by the user. For example, in the image of FIG. 3, Uncle Al can easily be segmented out of the image. Therefore, any location on Uncle Al would be considered part of the touch-sensitive zone.

In another embodiment, the user may draw a line which encloses the touch-sensitive zone. This may be by drawing with the user's finger on the touch-sensitive screen or any conventional method used in drawing or paint programs.

### Data Formats

In optional data format, playback information or at least a portion of the player or codec is merged into the file. As indicated above, it should have its own unique identifier, such as “*.tin”, or “*.tip”. The star “*” indicates where the filename would be. The “t” and “i” indicate that it is an image file that was tagged with an object.

The last letter relates to playback information. “p” indicates that playback information is embedded. “n” indicates no playback information is embedded.

In an alternative embodiment, the filename extension could use “*.sse” to indicate an OTI file. (Any other unique filename extensions may be used, provided that the naming and usage is consistent.)

### Tagged Image File, Embodiment 1:

In a first embodiment of the system, a packing device 113 merges the image file, an indication of the touch-sensitive, clickable, or otherwise selectable touch-sensitive zones (“sound spots”), and object data associated with each touch-sensitive zone into a “object tagged image file,” also referred to in this application as a “OTI file.” The file has a unique filename extension identifying it as an Object Tagged Image (OTI) file.

In this format, the object data, which may be sound clips, is merged into the file containing the image. Therefore, the object data is always available with the image data.

### Tagged Image File, Embodiment 2:

Information defining the decoding used by the player, such as the codec, may be embedded in the file. In this manner, the object data can always be played back, since the information defining a compatible player is now part of the file.

The datafile for this embodiment includes the same information as that for Embodiment 1 above, but additionally includes information as to how the recording device encoded the object data. This can be used to later encode additional tags if the recorder is no longer available.

Merge Code into Image

The files can get large when portions of the player and recorder are added to the file, even in abbreviated form. One way to make the files smaller is to use the least significant bits of the image file. This means of reducing file size may cause the colors of the image to be slightly altered.

Packing device 113 is responsible for merging the information above into an OTI file.

### User Interface

Even though the example above describes a touchscreen as a user interface, many other known user interfaces may be used. For example, it may be one of the group consisting of a touch-sensitive screen, a clicking input device, a mouse, trackpad, and other input device capable of selecting a location for embedding a touch-sensitive zone, even someday just looking at a touch-sensitive zone in a virtual reality device.

### Non-Volatile Memory Device Produced

By operating the system of FIG. 1 according to the process of FIGS. 2A-2D, a product by process is created. This product is a non-volatile memory 800 with a specific magnetic pattern stored on the non-volatile memory 800, such that when read by a compatible player 115, it displays the stored image and touch-sensitive zones and plays the object data related to each specific touch-sensitive zone when selected by the user.

The non-volatile memory 800 also may employ playback information indicating how the object can be decoded.

It also may include part or all of the playback device 115.

The current disclosure describes several embodiments of the invention. The actual coverage of the invention is not limited to these embodiments. A user input action assigned to each function as described above may be changed to other known user input actions and still fall under the spirit of the invention. Also, the invention covers all currently known computing devices and their input/output equipment. The current invention may be used on any of these.

Although a few examples have been shown and described, it will be appreciated by those skilled in the art that various changes and modifications might be made without departing from the scope of the invention, as defined in the appended claims.

What is claimed is:

1. A system 1000 for tagging an image 5 comprising:
a. a user interface 120 for displaying the image 5 to a user 1, and to acquire a plurality of user-defined locations and expand them into touch-sensitive zones on the image 5;
b. an object input device 102 adapted to acquire object data which may be visual or audible;
c. a memory 140 having memory locations for storing information provided to it;
d. a recording device 111 adapted to selectively receive object data from object input device 102 and store the object data in the memory 140;
e. a controller 110 coupled to the memory 140 adapted to run executable code stored in the executable memory 141, to control the user interface 120 to display the image 5, receive user input defining locations on the image, create touch-sensitive zones around the user-defined locations that may be selected by touching, clicking, or selecting them with a pointing device (user-selectable zones) 147, associate (tag) the touch-sensitive zones with object data acquired by the recording device 111, and store the image, tagged touch-sensitive zones and associated objects as a unitary file in the memory 140.

2. The system 1000 of claim 1 wherein the device adapted to acquire images employs prestored images as the acquired image.

3. The system 1000 of claim 1 wherein the device adapted to acquire images is a camera that acquires an image.

4. The system 1000 of claim 1 wherein the user interface 120 is a touch-sensitive screen.

5. The system 1000 of claim 1 wherein the object input device 102 is a microphone and the acquired object data is a sound clip that is associated with at least one touch-sensitive zone.

6. The system 1000 of claim 1 wherein the object input device 102 is a video camera and the acquired object is a video clip that is associated with at least one touch-sensitive zone.

7. The system 1000 of claim 5 wherein the sound clip is an audio description related to the image inside of the touch-sensitive zone.

8. An object tagged image (OTI) file having a uniform filename extension, created by the steps of:
a. acquiring an image 5;
b. displaying the image 5 to a user 1 on a user interface 120;
c. acquiring descriptive information about the image; that may include an audio description of the image;
f. identifying a plurality of user-selected locations on the image with the user interface 120;
g. expanding the acquired locations into touch-sensitive zones with a controller 110;
h. acquiring a plurality of sets of object data;
i. associating each set of object data with at least one touch-sensitive zone;
j. employing a packing device 113 to merge the image, touch-sensitive zones and sets of object data into an object tagged image (OTI) file; and
k. creating a readable pattern on non-volatile storage media representing the OTI file and including a filename having an indication that it is an OTI file.

8. The OTI file of claim 8, wherein the user interface 120 is a touch-sensitive screen.

9. A method of creating an object tagged image (OTI) file having a uniform filename extension, comprising the steps of:
a. acquiring an image;
b. displaying the image to a user on a user interface 120;
c. receiving descriptive information through the user interface 120 identifying the image;
d. receiving user input through the user interface 120 identifying a plurality of user-selected locations on the image;
e. expanding the acquired locations into a touch-sensitive zones;
f. acquiring a plurality of object data files and associating each with a touch-sensitive zone;
g. merging the image, touch-sensitive zone and object data files into an object tagged image (OTI) file; and
h. creating a magnetic representation of the OTI file in a non-volatile memory device including a filename having a uniform filename extension indicating that it is an OTI file.

10. The method of claim 9 wherein the descriptive information is an audio description of the image.

11. The method of claim 9 wherein the user interface 120 is a touch-sensitive screen.

12. The method of claim 9, wherein the step of acquiring an image comprises the step of: acquiring an image by one of:
a. capturing it with a camera, and
b. selecting an image previously stored in a memory.

13. The method of claim 9, wherein the step of acquiring an object data file comprises at least one of:
a. acquiring a sound clip;
b. acquiring a video clip; and
c. acquiring a computer animation.

14. A method of playing back a pre-stored object in an object tagged image (OTI) file, comprising the steps of:
a. employing a playback device 115 to acquire at least one file;
b. reading an indication of the acquired file format indicating that the file is an OTI file, by a controller 110;
c. extracting a prestored image from the OTI file;
d. displaying the image on a user interface 120;
e. identifying in the OTI file a plurality of touch-sensitive zones 147;
f. displaying the touch-sensitive zones 147 on the displayed image;
g. monitoring the user interface 120 to identify when a touch-sensitive zone has been selected by touch, click, or other selection using a pointing device;
h. playing an object with the playback device 115, that is associated with the touch-sensitive zone that was selected.

15. The method of claim 14 wherein the indication of the file format is an OTI file is a unique filename extension.

16. The method of claim 14 wherein the object file is a pre-recorded sound clip.

17. The method of claim 14 wherein the object file is a verbal description of a touch-sensitive zone.

18. The method of claim 14 wherein the touch-sensitive zone is made more visually prominent while the verbal description is being played.

19. The method of claim 18 wherein the touch-sensitive zone is made more visually prominent by at least one of highlighting the touch-sensitive zone and enlarging it on the user interface 120.

20. The method of claim 18, wherein the OTI file has executable code which is executed by the playback device to play back the OTI file.

21. A method of playing back all of the pre-stored objects in an object tagged image (OTI) file, comprising the steps of:
a. employing a playback device 115 to acquire at least one file;
b. reading an indication of the acquired file format indicating that the file is an OTI file, by a controller 110;
c. extracting a prestored image 5 from the OTI file;
d. displaying the image on a user interface 120;
e. identifying in the OTI file a plurality of touch-sensitive zones 147;
f. displaying an autoplay option on the displayed image;
g. monitoring the user interface 120 to identify when the autoplay option has been selected; and
h. playing all of the objects in the OTI file in a predetermined sequence with the playback device 115.

22. The method of claim 21 wherein a unique filename extension is used to indicate that the file format is an OTI file.

23. The method of claim 21 wherein the object file is a pre-recorded sound clip.

24. The method of claim 21 wherein the object file is a verbal description of the touch-sensitive zone portion of the image located in the user-selectable zone.

25. The method of claim 21 wherein a given touch-sensitive zone 147 is made more visually prominent while the audio associated with that touch-sensitive zone is being played.

26. The method of claim 25 wherein the touch-sensitive zone is made more visually prominent during playback by at least one of highlighting the touch-sensitive zone and enlarging the portion of the image 5 inside of the touch-sensitive zone on the user interface 120.

27. The method of claim 25, wherein the OTI file 149 has executable code which is executed by the playback device to play back the OTI file.
